(19) United States
(12) Patent Application Publication
(10) Pub. No.: US 2024/0309475 A1
(43) Pub. Date: Sep. 19, 2024

(54) A METHOD FOR PROCESSING IRON ORE TO OBTAIN STEEL

(71) Applicant: METSO METALS OY, Espoo (FI)

(72) Inventors: Timo HAIMI, Espoo (FI); Olli PEKKALA, Espoo (FI)

(21) Appl. No.: 18/575,895

(22) PCT Filed: Jul. 6, 2021
(86) PCT No.: PCT/FI2021/050526

§ 371 Date: Jan. 2, 2024

(51) Int. Cl. C21B 13/00; C21B 13/12; C21C 7/064

(52) U.S. Cl. CPC C21B 13/0006; C21B 13/008; C21B 13/12; C21C 7/064

(57) ABSTRACT

A method for processing iron ore to obtain steel by feeding the DRI into a smelting furnace so as to obtain an intermediate iron product, which is then subsequently introduced into a conversion unit for obtaining steel form the intermediate iron product. Moreover, carbon is introduced into the process. As a consequence, a suitable carbon content may be achieved for the intermediate iron product such that impurities of the intermediate iron product may be reduced along with carbon contents thereof in a steel conversion process without sacrificing iron contents of the intermediate iron product. Simultaneously, suitable fluxes are fed into the smelting furnace together with the DRI, such that high-quality slag suitable as raw material for further processing is obtained therefrom. An associated smelting furnace arrangement is also disclosed.

The present disclosure relates to steelmaking, and more particularly to a method obtaining steel from direct reduced iron (DRI).

### BACKGROUND OF THE DISCLOSURE

Previously known methods for producing steel from DRI requires the use of high-grade iron ore. This is because iron content of the ore is not melted during the DRI reduction process, and consequently, the iron portion of the ore is not separated from the gauge portion thereof during reduction. Consequently, the DRI obtained from low-grade DRI entrails a relatively large amount of gangue and impurities.

Moreover, in previously known methods of DRI steelmaking, the DRI is introduced into a smelting furnace, where the carbon content is reduced to a suitable level for steel already in connection with the smelting process. This is possible, because a relatively small amount of coal, if any, is introduced to the DRI in connection with the reduction process. In comparison, steel making processes based on pig iron obtained from a blast furnace, where carbon is introduced in large amounts in the form of coke, require a separate steel conversion process for the removal of carbon in connection with other impurities. As known methods of DRI steelmaking result in a low carbon content during the smelting process, any subsequent oxidizing removal of impurities results in additional loss of iron.

### BRIEF DESCRIPTION OF THE DISCLOSURE

An object of the present disclosure is to provide a method for processing iron ore to obtain steel such that a direct reduction process may be used in connection with lower grade iron ore.

The object of the disclosure is achieved by method which are characterized by what is stated in the independent claim. The preferred embodiments of the disclosure are disclosed in the dependent claims.

The disclosure is based on the idea of feeding the DRI into a smelting furnace so as to obtain an intermediate iron product, which is then subsequently introduced into a conversion unit for obtaining steel form the intermediate iron product. Moreover, carbon is introduced into the process either in connection with the direct reduction of the iron or as a carbon containing solid in connection with the smelting of the DRI. As a consequence, a suitable carbon content may be achieved for the intermediate iron product such that impurities of the intermediate iron product may be reduced along with carbon contents thereof in a steel conversion process without sacrificing iron contents of the intermediate iron product. Simultaneously, suitable fluxes are fed into the smelting furnaces together with the DRI, such that high-quality slag suitable as raw material for further processing is obtained therefrom.

As a result, steel with low amount of impurities is obtained from low quality ore via the DRI-process, without excessive loss of iron content in the steel conversion process, while simultaneously enabling further use of the relatively large amount of slag obtained in connection (as compared to using high-quality ore).

### BRIEF DESCRIPTION OF THE DRAWINGS

In the following the disclosure will be described in greater detail by means of preferred embodiments with reference to the accompanying drawings, in which

FIG. 1 schematically illustrates method steps according to an embodiment of the present disclosure

FIG. 2 schematically illustrates a smelting furnace arrangement according to an embodiment of the present disclosure

### DETAILED DESCRIPTION OF THE DISCLOSURE

According to a first aspect of the present disclosure, a method for processing iron ore to obtain steel is provided. It should be noted, that in the context of this disclosure, the term iron ore encompasses beneficiated iron ore.

The method comprising a step of introducing iron ore 101 into a gas reduction unit so as to subject said iron ore to a direct reduction process 100 for obtaining direct reduced iron. For example, a reduction kiln may be used as the gas reduction unit.

Particularly, the iron ore used is of a relatively low grade, i,e., it comprises a silica (SiO₂) content of at least 3% by mass, an iron content of no more than 65% by mass, and a phosphorus oxide (P₂O₅) content of at least 0.015% by mass. Preferably, the iron ore comprises an iron content of between 50%-65% by mass, and more preferably the iron ore comprises an iron content of between 55%-65% by mass. Suitably, the iron ore may comprise a phosphorus oxide (P₂O₅) content of at least 0.030% by mass.

The direct reduced iron received from the reduction unit is then introduced 201 into a smelting furnace 1, so as to subject said direct reduced iron to a smelting process 200 for obtaining an intermediate iron product and slag. Due to the relatively low grade of the iron ore used, a ratio of slag to intermediate iron product obtained from the smelting process is 0.1 by mass, or higher. For example, the ratio of slag to intermediate iron product obtained from the smelting process may be 0.2 by mass, or higher. For example, the ratio of slag to intermediate iron product obtained from the smelting process may be up to 2.0 by mass.

One or more flux materials are also introduced 202 into the smelting furnace 1 in connection with the smelting process 200, so as to adjust slag composition. Examples of such flux materials include quartz, lime or limestone, dolomite, bauxite and recycled slag. For example, the slag composition may be adjusted by one or more of the following ways: the amount of quartz may be varied to adjust the amount of silica in the obtained slag, the amount of lime, limestone and/or dolomite may be varied to adjust the amount of calcium oxide in the obtained slag, and the amount of bauxite may be varied to adjust the amount of aluminium oxide in the obtained slag. Naturally, other fluxes may be introduced so as to adjust the composition of the slag obtained from the smelting furnace.

Particularly, smelting furnace 1 is of a stationary, non-tilting-type having a holding capacity of between 1000-3000 tonnes iron. Such a holding capacity of the smelting furnace ensures a sufficient retention time is in order to achieve better separation of the slag and molten intermediate iron product, thus resulting in a better quality of slag (i.e. less residue from intermediate iron ore product). Moreover, a combined calcium oxide (CaO), magnesium oxide (MgO) and silica (SiO₂) content by mass of the slag obtained from the smelting process exceeds ⅔ of the total contents thereof.

The slag obtained from the smelting process 200 has a basicity above 0.8, as determined by the ratio of calcium oxide (CaO) and magnesium oxide (MgO) to silica (SiO₂), i.e. (CaO+MgO/SiO₂).

Preferably, but not necessarily, the slag obtained from the smelting process 200 has a basicity of above 1. Suitably, the slag obtained from the smelting process 200 has a basicity of below 1.7. More preferably, but not necessarily, the slag obtained from the smelting process 200 has a basicity of between 1 and 1.7. Most preferably, but not necessarily, the slag obtained from the smelting process 200 has a basicity of between 1 and 1.5.

Preferably, but not necessarily, the slag obtained from the smelting process 200 may comprise a calcium oxide (CaO) content of at least 30% by mass, an aluminium oxide (Al₂O₃) content of at least 10.5% by mass, a silica (SiO₂) content of no more than 40% by mass, and a magnesium oxide (MgO) content of no more than 15% by mass. As mentioned above, the type and amount of fluxes introduced into the smelting furnace 1 are varied such that a desired slag composition is achieved.

Furthermore, the method comprises a step of introducing carbon 401 so as to increase a carbon content of the obtained intermediate iron product to between 1%-4% by mass. For example, carbon may be introduced during either or both of the direct reduction process 100 and the smelting process 200, as described in further detail hereafter.

The method further comprises a step of introducing the intermediate iron 301 product into a steel conversion unit so as to subject said intermediate iron product to a steel conversion process 300 for reducing a phosphorus content and the carbon content of said intermediate iron product, and to obtain steel 501 having an carbon content of no more than 0.5% by mass. Increasing the carbon content of the intermediate iron product prior to the steel conversion process enables efficient phosphorus reduction without excessive loss of iron. This is because oxygen blown towards the molten bath during the steel conversion process is able to reacts with carbon instead of iron, thereby preventing excessive iron loss.

In an embodiment of the first aspect according to the present disclosure, introducing carbon 401 comprises introducing a carbon containing gas in the reduction unit in connection with the direct reduction 100 of iron ore. Examples of such carbon containing gases include natural gas, such as methane (CH4), carbon monoxide (CO) and gasified coke. Naturally, such a carbon containing gas may be a mixture of one or more gaseous compositions, including the ones mentioned above.

In an embodiment of the first aspect according to the present disclosure, introducing carbon 401 comprises introducing a carbon containing solid into the smelting furnace 1 in connection with the smelting 200. Most suitably, such a carbon containing solid is of a non-fossil origin, such as bio char or wood charcoal, although other types carbon of carbon containing solids (i.e., of a fossil origin) may be used. For example, a carbon containing solid of a recycled origin may be used. Naturally, a mixture of different types of carbon containing solids may also be used.

Introducing a carbon containing solid 401 into the smelting furnace 1 is particularly suitable when a carbon contents of a reductant gas used in the reduction process 100 is very low or non-existent. For example, hydrogen may be used partially or wholly as the reductant in the reduction process 100.

In an embodiment of the first aspect according to the present disclosure, introducing carbon 401 comprises introducing carbon into the smelting furnace 1 together with the direct reduced iron such that said carbon is carried along with the direct reduced iron into a molten bath.

That is, regardless of whether the carbon is introduced 401 as a carbon containing gas into the reduction unit or as a carbon containing solid into the smelting furnace 1, the introduced carbon is suitably introduced 401 into the smelting furnace 1 together with the direct reduced iron either as an integrated or separate portion thereof.

More specifically, in the latter case, the carbon containing solid is suitably introduced 401 into the smelting furnace in connection with smelting 200 by feeding said carbon containing solid together with the direct reduced iron. That is, the carbon containing solid suitably fed simultaneously with the direct reduced iron through a common feed tube 5.

Preferably, but not necessarily, the carbon containing solid is mixed with the direct reduced iron prior to introduction into the smelting furnace 1, such that said carbon containing solid is entrained with the direct reduced iron into a molten bath. For example, mixing of the direct reduced iron and the carbon containing solid may be done in a feed tube 5 of the smelting furnace 1. Preferably, but not necessarily, the direct reduced iron may be provided in a dedicated DRI container 3, such as a silo, associated with the smelting furnace 1, while the carbon containing solid may be provided in dedicated carbon container 4, such as silo, also associated to the smelting furnace 1. Moreover, in such a case, the direct reduced iron and the carbon containing solid may be introduced 401 into the smelting furnace 1 along a common feed tube 5, in which the two are mixed.

In an embodiment of the first aspect according to the present disclosure, the steel conversion process 300 may be carried out in a converter, a ladle or an electric arc furnace having 1-3 electrodes (i.e. a scrap melting EAF).

In an embodiment of the first aspect according to the present disclosure, during the steel conversion process 300, the carbon content of the steel obtained therefrom is reduced to no more than 25% by weight of the original carbon content of the intermediate iron product.

For example, if the intermediate iron product obtained from the smelting process 200 has a carbon content of 1% by mass, the carbon content is reduced during the steel conversion process 300 such that the steel obtained therefrom has a carbon content of no more than 0.25% by mass.

In an embodiment of the first aspect according to the present disclosure, the intermediate iron product is subjected to a desulphurization process before introduction 301 into the steel conversion unit, preferably by injection of a reagent into the intermediate iron product in molten state. For example, calcium carbide, magnesium carbonate, sodium carbonate, and lime, or any combination thereof may be used as a suitable reagent for desulphurization.

In an embodiment of the first aspect according to the present disclosure, no more than 1% of external scrap metal is introduced into the smelting furnace, with respect to metallic furnace feed.

In the context of this disclosure, the term external scrap metal encompasses scrap metal having a quality different from that resulting from the method. That is, internal scrap metal (i.e., of a same quality as that originating from the method) may be introduced in larger quantities to the smelting furnace. Particularly, scrap metal originating from within the facility in which the method is taking place may be used in larger quantities than external scrap metal.

In an embodiment of the first aspect according to the present disclosure, the smelting furnace 1 used for the smelting process is an electric furnace.

Preferably, but not necessarily, the smelting furnaces 1 is an open slag bath furnace or a semi-open slag bath furnace.

More preferably, but not necessarily, the smelting furnaces 1 is a six-in-line furnace. That is the smelting furnace 1 comprises six electrodes 2 arranged in a line formation. Alternatively, the smelting furnace 1 may comprise six electrodes arranged in two groups of three electrodes, each group forming a triangular pattern.

In an embodiment of the first aspect according to the present disclosure, the smelting furnace 1 has a width dimension and a length dimension, wherein the length dimension is at least 2.5 times the width dimension. Most suitably, the length dimension is at least 4 times the width dimension.

In an embodiment of the first aspect according to the present disclosure, the smelting furnace 1 has a footprint of a generally rectangular shape.

In an embodiment of the first aspect according to the present disclosure, the smelting furnace 1 may be equipped with a dedicated DRI container 3 for holding direct reduced iron, a dedicated carbon container 4 for holding a carbon containing solid, and a common feed tube 5 for introducing both direct reduced iron and carbon containing solid into the smelting furnace 1 as a heap above a slag layer. That is, the direct reduced iron and the carbon containing solid are stored separately before being introduced into the smelting furnace 1. This allows the storage of direct reduced iron at an elevated temperature, without the risk of the of carbon monoxide being formed by the carbon containing solid.

Furthermore, the direct reduced iron and the carbon containing solid may be mixed within the common feed tube 5, prior to being introduced into the furnace 1, with a mixer 5a provided in connection with the common feed tube so.

Moreover, a mixture of direct reduced iron and the carbon containing solid may be introduced through the common feed tube 5 at a position being in a transverse direction between an electrode 2 and the lateral wall 1a, preferably at a distance from the lateral wall 1a of no more than one third of the distance between the lateral wall 1a and the electrode 2.

For example, the smelting furnace 1 may be equipped with at least ten, preferably twelve, dedicated DRI containers 3 each having an associated feed tube for introducing direct reduced iron into the smelting furnace. Most suitably, the DRI containers 3 and their associated feed tubes are arranged as transversally opposing pairs with respect to the electrodes, the opposing pairs being equally spaced apart from the electrodes in the longitudinal direction.

For example, the smelting furnace 1 may be equipped with at least four, preferably six and more preferably twelve carbon containers 4 associated to feed tubes 5 of the DRI containers 3, so as to form common feed tubes 5 for introducing both direct reduced iron and carbon containing solid into the smelting furnace 1 as a heap above a slag layer.

Should the number of carbon containers 4 differ from the number of DRI containers 3, the carbon 4 containers are preferably arranged such that that common feed tubes 5 associated to both DRI containers 3 and carbon containers 4 are arranged as transversally opposing pairs with respect to the electrodes, the opposing pairs being equally spaced apart from the electrodes 2 in the longitudinal direction.

It should be noted that the first aspect of the present disclosure encompasses two or more embodiments, or variants thereof, as discussed above.

According to a second aspect of the present disclosure, a method for processing iron ore to obtain steel is provided.

The method comprising a step introducing iron ore 101 into a gas reduction unit so as to subject said iron ore to a direct reduction process 100 for obtaining direct reduced iron. For example, a reduction kiln may be used as the gas reduction unit.

Particularly, the iron ore used is of a relatively low grade, i,e., it comprises a silica (SiO₂) content of at least 3% by mass, an iron content of no more than 65% by mass, and a phosphorus oxide (P₂O₅) content of at least 0,015% by mass. Preferably, the iron ore comprises an iron content of between 50%-65% by mass, and more preferably the iron ore comprises an iron content of between 55%-65% by mass. Suitably, the iron ore may comprise a phosphorus oxide (P₂O₅) content of at least 0,030% by mass.

The direct reduced iron received from the reduction unit is then introduced 201 into a smelting furnace 1, so as to subject said direct reduced iron to a smelting process 200 for obtaining an intermediate iron product and slag. Due to the relatively low grade of the iron ore used, a ratio of slag to intermediate iron product obtained from the smelting process is 0.1 by mass, or higher. For example, the ratio of slag to intermediate iron product obtained from the smelting process 200 may be 0.2 by mass, or higher. For example, the ratio of slag to intermediate iron product obtained from the smelting process 200 may be up to 2.0 by mass.

One or more flux materials are also introduced 202 into the smelting furnace in connection with the smelting process 200, so as to adjust slag composition. Examples of such flux materials include quartz, lime(stone?) dolomite, bauxite and recycled slag. For example, the slag composition may be adjusted by one or more of the following ways: the amount of quartz may be varied to adjust the amount of silica in the obtained slag, the amount of lime(stone?) and/or dolomite may be varied to adjust the amount of calcium oxide in the obtained slag, and the amount of bauxite may be varied to adjust the amount of aluminum oxide in the obtained slag. Naturally, other fluxes may be introduced so as to adjust the composition of the slag obtained from the smelting furnace.

Particularly, the smelting furnace 1 is of a stationary, non-tilting-type

Moreover, a combined calcium oxide (CaO), magnesium oxide (MgO) and silica (SiO₂) content by mass of the slag obtained from the smelting process exceeds ⅔ of the total contents thereof.

The slag obtained from the smelting process 200 has a basicity above 0.8, as determined by the ratio of calcium oxide (CaO) and magnesium oxide (MgO) to silica (SiO₂), i.e. (CaO+MgO/SiO₂).

Preferably, but not necessarily, the slag obtained from the smelting process 200 has a basicity of above 1. Suitably, the slag obtained from the smelting process 200 has a basicity of below 1.7. More preferably, but not necessarily, the slag obtained from the smelting process 200 has a basicity of between 1 and 1.7. Most preferably, but not necessarily, the slag obtained from the smelting process 200 has a basicity of between 1 and 1.5.

Preferably, but not necessarily, the slag obtained from the smelting process 200 comprises a calcium oxide (CaO) content of at least 30% by mass, an aluminium oxide (Al203) content of at least 10.5% by mass, a silica (SiO2) content of no more than 40% by mass, and a magnesium oxide (MgO) content of no more than 15% by mass. As mentioned above, the type and amount of fluxes introduced into the smelting furnace are varied such that a desired slag composition is achieved.

Furthermore, the method comprises a step of introducing carbon 401 so as to increase a carbon content of the obtained intermediate iron product to between 1%-4% by mass, by introducing a carbon containing solid 401 into the smelting furnace 1 in connection with the smelting 200. As discussed above in connection with the first aspect of the present disclosure, the carbon containing solid is suitably carried along with the direct reduced iron into a molten bath, for example, by feeding said carbon containing solid 401 together with the direct reduced iron.

The method further comprises a step of introducing the intermediate iron product 301 into a steel conversion unit so as to subject said intermediate iron product to a steel conversion process 300 for reducing a phosphorus content and the carbon content of said intermediate iron product, and to obtain steel 501 having a carbon content of no more than 0.5% by mass. Increasing the carbon content of the intermediate iron product prior to the steel conversion process enables efficient phosphorus reduction without excessive loss of iron. This is because oxygen blown towards the molten bath during the steel conversion process is able to reacts with carbon instead of iron, thereby preventing excessive iron loss.

It should be noted that the embodiment, and variants thereof, discussed above in connection with the first aspect of the present disclosure are equally applicable with and encompassed by the second aspect of the disclosure.

According to a third aspect of the present disclosure, a smelting furnace 1 arrangement for smelting direct reduced iron, so as to obtain an intermediate iron product and slag, is provided. The smelting furnace 1 comprises a a rectangular footprint delimited by longitudinally extending lateral walls 1a and end walls 1b extending transversally to the lateral walls. Moreover, the smelting furnace 1 comprises six electrodes 2 arranged in an in-line configuration along a longitudinal direction, the electrodes 2 being suitably arranged centrally in the transverse direction.

The smelting furnace arrangement further comprises at least a dedicated DRI container 3 for holding direct reduced iron, a dedicated carbon container 4 for holding a carbon containing solid, and a common feed tube 5 for introducing both direct reduced iron and carbon containing solid into the smelting furnace as a heap above a slag layer. That is, the direct reduced iron and the carbon containing solid are stored separately before being introduced into the smelting furnace 1. This allows the storage of direct reduced iron at an elevated temperature, without the risk of the of carbon monoxide being formed by the carbon containing solid.

Furthermore, a mixer 5a is provided in connection with the common feed tube 5 so as to mix the direct reduced iron and the carbon containing solid prior to being introduced into the furnace.

Moreover, the common feed tube is arranged in a transverse direction between an electrode 2 and the lateral wall 1a, preferably at a distance from the lateral wall 1a of no more than one third of the distance between the lateral wall 1a and the electrode 2.

For example, the smelting furnaces 1 is an open slag bath furnace or a semi-open slag bath furnace.

For example, the smelting furnace 1 may have a longitudinal a length dimension and a transverse width dimension, wherein the length dimension is at least 2.5 times the width dimension. Most suitably, the length dimension is at least 4 times the width dimension.

In an embodiment according to the third aspect of the present disclosure, the smelting furnace 1 comprises at least ten, preferably twelve, dedicated DRI containers 3 each having an associated feed tube for introducing direct reduced iron 201 into the smelting furnace. Most suitably, the DRI containers 3 and their associated feed tubes are arranged as transversally opposing pairs with respect to the electrodes 2, the opposing pairs being equally spaced apart from the electrodes 2 in the longitudinal direction.

In an embodiment according to the third aspect of the present disclosure, the smelting furnace 1 arrangement comprises at least four, preferably six and more preferably twelve carbon containers 4 associated to feed tubes 5 of the DRI containers 3, so as to form common feed tubes 5 for introducing both direct reduced iron 201 and carbon containing solid 401 into the smelting furnace as a heap above a slag layer.

Should the number of carbon containers 4 differ from the number of DRI containers 3, the carbon containers 4 are preferably arranged such that that common feed tubes 5 associated to both DRI containers 3 and carbon containers 4 are arranged as transversally opposing pairs with respect to the electrodes 2, the opposing pairs being equally spaced apart from the electrodes 2 in the longitudinal direction.

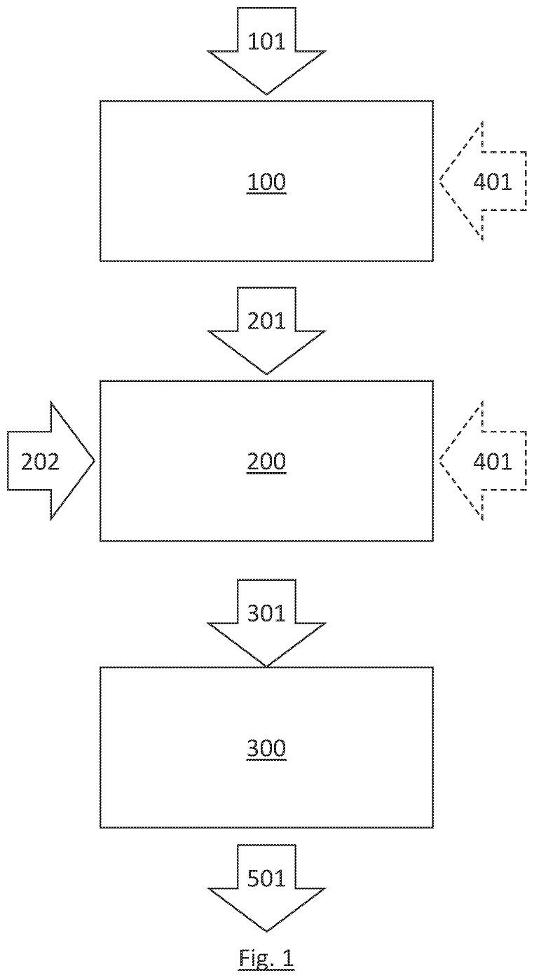

FIG. 1 schematically illustrates method steps according to an embodiment of the present disclosure. In the direct reduction process 100, iron ore 101 is introduced into a gas reduction unit and direct reduced iron is obtained.

The obtained direct reduced iron is then introduced 201 into a smelting process 200 form which an intermediate iron product and slag is obtained. Also, one or more flux materials 202 are introduced into the smelting process so as achieve slag of a suitable composition. The slag obtained may then be used further, e.g. as a raw material in the concrete industry.

The obtained intermediate product is introduced 301 into steel conversion process 300 from which steel is obtained 501.

Particularly, carbon is introduced into the process at either or both of the direct reduction process 100 as a carbon containing reductant gas or the smelting process 200 as a carbon containing solid

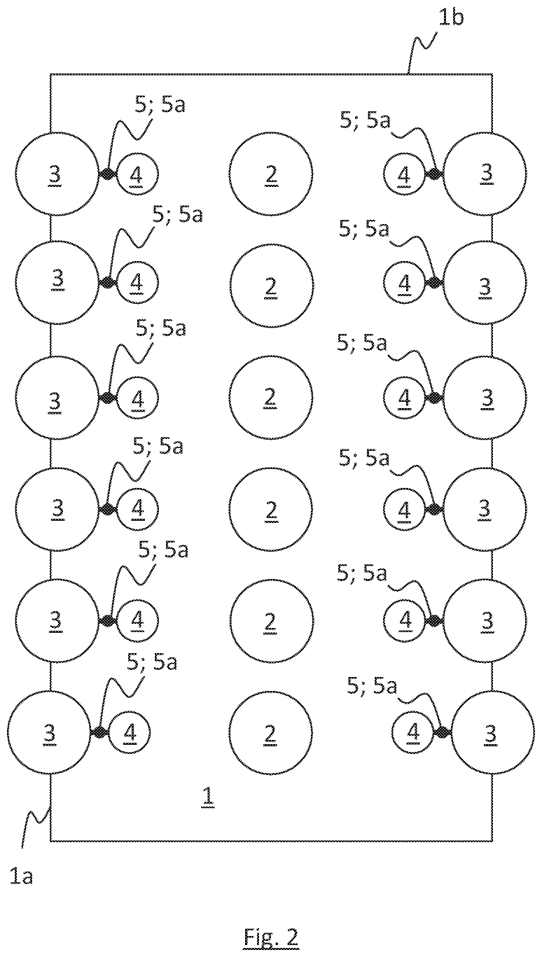

FIG. 2 schematically illustrates method steps according to an embodiment of the present disclosure. Particularly, the smelting furnace 1 has a rectangular footprint with opposing, mutually parallel lateral walls 1 extending along the longitudinal direction, and opposing, mutually parallel end walls 1b transverse to the lateral walls. The smelting furnace is equipped with six electrodes 2, arranged longitudinally in an in-line configuration, and centrally with respect to the transverse direction.

On both transverse sides of each electrode 2, a common feed tube 5 is arranged for introducing direct reduced iron and a carbon containing solid into the furnace from a DRI container 3 and a carbon container 4, respectively.

The common feed tube 5 is equipped with a mixer 5a for mixing the direct reduced iron with the carbon containing solid within the common feed tube. Moreover, the common feed tube 5 is arranged so as to discharge such a mixture into the furnace between the respective electrode 2 and the lateral wall 1 at distance closer to the lateral wall 1a than to the electrode 2. Particularly, the discharge of the common feed tube 5 is arranged at a distance from the lateral wall of no more than ⅓ of the distance between the lateral wall and the electrode.

### LIST OF REFERENCE NUMERALS

1 smelting furnace
1a lateral wall
1b end wall
2 electrode
3 DRI container
4 carbon container
5 common feed tube
5a mixer
100 direct reduction process
101 introducing iron ore
200 smelting process
201 introducing direct reduced iron
202 introducing one or more flux material
300 steel conversion process
301 introducing intermediate iron product
401 introducing carbon
501 obtaining steel

1.-24. (canceled)

25. A method for processing iron ore to obtain steel, the method comprising the steps of:
introducing iron ore into a gas reduction unit so as to subject said iron ore to a direct reduction process for obtaining direct reduced iron, wherein said iron ore comprises:
a silica (SiO2) content of at least 3% by mass,
an iron content of no more than 65% by mass, and
a phosphorus oxide (P2O5) content of at least 0.015% by mass;
introducing said direct reduced iron into a smelting furnace so as to subject said direct reduced iron to a smelting process for obtaining an intermediate iron product and slag,
wherein a ratio of slag to intermediate iron product obtained from the smelting process is 0.1 by mass, or higher, and
introducing one or more flux materials into the smelting furnace in connection with the smelting process so as to adjust slag composition wherein the smelting furnace is an electric furnace of a stationary, non-tilting-type having a holding capacity of between 1000-3000 tonnes iron,
wherein a combined calcium oxide (CaO), magnesium oxide (MgO) and silica (SiO2) content by mass of the slag obtained from the smelting process exceeds ⅔ of the total contents thereof, and said slag has a basicity above 0.8, and wherein said method further comprises the steps of:
introducing carbon so as to increase a carbon content of the obtained intermediate iron product to between 1%-4% by mass, and
introducing the intermediate iron product into a steel conversion unit so as to subject said intermediate iron product to a steel conversion process for reducing a phosphorus content and the carbon content of said intermediate iron product, and to obtain steel having an carbon content of no more than 0.5% by mass
wherein introducing carbon comprises introducing a carbon containing solid into the smelting furnace in connection with the smelting by feeding said carbon containing solid together with the direct reduced iron, such that said carbon is carried along with the direct reduced iron into a molten bath, and
wherein the direct reduced iron and the carbon containing solid are stored separately before being introduced into the smelting furnace, and are subsequently introduced into the smelting furnace with a feed tube as a heap above a slag layer.

26. The method according to claim 25, wherein the slag obtained from the smelting process comprises:
a calcium oxide (CaO) content of at least 30% by mass
an aluminium oxide (Al₂O₃) content of at least 10.5% by mass,
a silica (SiO₂) content of no more than 40% by mass, and
a magnesium oxide (MgO) content of no more than 15% by mass.

27. The method according to claim 25, wherein introducing carbon comprises:
introducing a carbon containing gas in the reduction unit in connection with the direct reduction of iron ore.

28. The method according to claim 25, wherein the carbon containing solid is mixed with the direct reduced iron prior to introduction into the smelting furnace, such that said carbon containing solid is entrained with the direct reduced iron into a molten bath.

29. The method according to claim 25, wherein the carbon containing solid is of a non-fossil or recycled origin.

30. The method according to claim 25, wherein hydrogen is used, partially or wholly, as the reductant in the reduction process.

31. The method according to claim 25, wherein the steel conversion process is carried out in a converter, a ladle or an electric arc furnace having 1-3 electrodes.

32. The method according to claim 25, wherein the steel conversion process, the carbon content of the steel obtained is reduced to no more than 25% by weight of the original carbon content of the intermediate iron product.

33. The method according to claim 25, wherein the intermediate iron product is subjected to a desulphurization process before introduction into the steel conversion unit.

34. The method according to claim 25, wherein, with respect to metallic furnace feed, no more than 1% of external scrap metal is introduced into the smelting furnace.

35. The method according to claim 25, wherein at least the direct reduced iron is introduced into the furnace between an electrode and a lateral wall of the furnace such that a heap extending above a slag layer is formed,
wherein the heap is positioned closer to said lateral wall than to said electrode,
wherein the at least direct reduced iron being introduced into the smelting furnace at a position having a distance from said lateral wall of no more than one third of the distance between said electrode and said lateral wall, and
wherein the heap extends 0.1-2 m above the slag layer.

36. The method according to claim 25, wherein the furnace is an open slag bath furnace or a semi-open slag bath furnace.

37. The method according to claim 25, wherein the furnace has six electrodes arranged in either a six-in-line-configuration or as two groups of three electrodes, each group forming a triangular pattern.

38. The method according to claim 25, wherein the smelting furnace has a width dimension and a length dimension, wherein the length dimension is at least 2.5 times the width dimension.

39. The method according to claim 25, wherein the smelting furnace has a footprint of a generally rectangular shape.

40. A method for processing iron ore to obtain steel, the method comprising the steps of:
introducing iron ore into a gas reduction unit so as to subject said iron ore to a direct reduction process for obtaining direct reduced iron,
wherein said iron ore comprises:
a silica (SiO2) content of at least 3% by mass,
an iron content of no more than 65% by mass, and
a phosphorus (P2O5) oxide content of at least 0.015% by mass;
introducing said direct reduced iron into a smelting furnace so as to subject said direct reduced iron to a smelting process for obtaining an intermediate iron product and slag,
wherein a ratio of slag to intermediate iron product obtained from the smelting process is 0.1 by mass, or higher, and
introducing one or more flux materials into the smelting furnace in connection with the smelting process so as to adjust slag composition
wherein the smelting furnace is an electric furnace of a stationary, non-tilting-type,
wherein a combined calcium oxide (CaO), magnesium oxide (MgO) and silica (SiO2) content by mass of the slag obtained from the smelting process exceeds ⅔ of the total contents thereof, and said slag has a basicity above 0.8, and
wherein said method further comprises the steps of:
introducing carbon so as to increase a carbon content of the obtained intermediate iron product to between 1%-4% by mass, by introducing a carbon containing solid into the smelting furnace in connection with the smelting, and
introducing the intermediate iron product into a steel conversion unit so as to subject said intermediate iron product to a steel conversion process for reducing a phosphorus content and the carbon content of said intermediate iron product, and to obtain steel having an carbon content of no more than 0.5% by mass
wherein introducing carbon comprises introducing a carbon containing solid into the smelting furnace in connection with the smelting by feeding said carbon containing solid together with the direct reduced iron, such that said carbon is carried along with the direct reduced iron into a molten bath, and
wherein the direct reduced iron and the carbon containing solid are stored separately before being introduced into the smelting furnace, and are subsequently introduced into the smelting furnace with a feed tube as a heap above a slag layer.

41. The method according to claim 40, wherein the slag obtained from the smelting process comprises:
a calcium oxide (CaO) content of at least 30% by mass
an aluminium oxide (Al203) content of at least 10.5% by mass,
a silica (SiO2) content of no more than 40% by mass, and
a magnesium oxide (MgO) content of no more than 15% by mass.

42. A smelting furnace arrangement for smelting direct reduced iron, so as to obtain an intermediate iron product and slag, comprising a smelting furnace having a rectangular footprint delimited by longitudinally extending lateral walls and end walls extending transversally to the lateral walls,
wherein the smelting furnace comprises six electrodes arranged in an in-line configuration along a longitudinal direction, the electrodes being arranged centrally in the transverse direction,
wherein the smelting furnace arrangement comprises:
at least a dedicated DRI container for holding direct reduced iron,
a dedicated carbon container for holding a carbon containing solid,
a common feed tube for introducing both direct reduced iron and carbon containing solid into the smelting furnace as a heap above a slag layer
wherein a mixer is provided in connection with the common feed tube so as to mix the direct reduced iron and the carbon containing solid prior to being introduced into the furnace, and
wherein the common feed tube is arranged in a transverse direction between an electrode and the lateral wall.

43. The smelting furnace arrangement according to claim 42, characterized by the smelting furnace comprising at least ten, dedicated DRI containers each having an associated feed tube for introducing direct reduced iron into the smelting furnace, wherein the DRI containers and their associated feed tubes are arranged as transversally opposing pairs with respect to the electrodes, the opposing pairs being equally spaced apart from the electrodes in the longitudinal direction.

44. The smelting furnace arrangement according to claim 42, characterized by comprising at least four carbon containers associated to feed tubes of the DRI containers, so as to form common feed tubes for introducing both direct reduced iron and carbon containing solid into the smelting furnace as a heap above a slag layer.
